(19) United States
(12) Patent Application Publication
(10) Pub. No.: US 2023/0397128 A1
(43) Pub. Date: Dec. 7, 2023

(54) ADJUSTING TRANSMISSION POWER BASED ON INTERFERENCE MEASUREMENT AND/OR ACKNOWLEDGEMENT FEEDBACK

(71) Applicant: Lenovo (Singapore) Pte. Ltd., New Tech Park (SG)

(72) Inventors: Karthikeyan Ganesan, Kronberg im Taunus (DE); Ankit Bhamri, Rödermark (DE); Ali Ramadan Ali, Kraiburg am Inn (DE)

(21) Appl. No.: 18/249,204

(22) PCT Filed: Oct. 14, 2021
(86) PCT No.: PCT/IB2021/059476

§ 371 Date: Apr. 14, 2023

Related U.S. Application Data
(63) Continuation-in-part of application No. PCT/IB2021/058381, filed on Sep. 14, 2021.
(60) Provisional application No. 63/091,793, filed on Oct. 14, 2020.

(51) Int. Cl. H04W 52/36; H04W 52/24; H04B 17/336

(52) U.S. Cl. CPC H04W 52/367; H04W 52/241; H04B 17/336

(57) ABSTRACT

Apparatuses, methods, and systems are disclosed for non-LBT based fair coexistence. One apparatus includes a processor and a transceiver that receives a measurement configuration from a network node indicating a measurement resource and time window for performing interference measurement. The processor configures a ZP-CSI-RS for performing long-term interference measurement according to the measurement configuration and performs detection activity including A) performing an interference measurement on a plurality of beams within a configured time window using the configured measurement resource, and/or B) receiving acknowledgment feedback from the network node for intra-network transmission. The processor determines an interference amount based on the detection activity and adjusts a UE transmission power for an UL physical channel transmission based on the determined amount of interference.

### CROSS-REFERENCE TO RELATED APPLICATIONS

This application claims priority to U.S. Provisional Patent Application No. 63/091,793 entitled “NON-LBT BASED FAIR COEXISTENCE MECHANISM” and filed on Oct. 14, 2020 for Karthikeyan Ganesan, Ankit Bhamri, and Ali Ramadan Ali, which application is incorporated herein by reference.

This application also claims priority to International Patent Application Number PCT/IB2021/058381 entitled “CHANNEL-SENSING MEASUREMENT AND CHANNEL ACCESS REPORT” and filed on Sep. 14, 2021 for Ankit Bhamri, Karthikeyan Ganesan, Alexander Johann Maria Golitschek Edler von Elbwart, Ali Ramadan Ali, and Vijay Nangia, which application claims priority to U.S. Provisional Patent Application No. 63/078,294 entitled “REFERENCE SIGNAL AND REPORTING FOR LONG-TERM SENSING FOR UNLICENSED CHANNEL ACCESS” and filed on Sep. 14, 2020 for Ankit Bhamri, Karthikeyan Ganesan, Alexander Johann Maria Golitschek Edler von Elbwart, Ali Ramadan Ali, and Vijay Nangia, which applications are also incorporated herein by reference.

### FIELD

The subject matter disclosed herein relates generally to wireless communications and more particularly relates to a Listen-Before-Talk (“LBT”) free fair coexistence mechanism for directional transmission and/or reception.

### BACKGROUND

For operation in unlicensed spectrum (also referred to as shared spectrum) because a channel may be shared among various, unrelated users it is possible that a particular user (i.e., a User Equipment (“UE”)) may experience inter-network interference and/or inter-system interference. Currently for sub-6 GHz NR-U, only short-term channel sensing in the form of omni-directional LBT is supported.

### BRIEF SUMMARY

Disclosed are procedures for non-LBT based fair coexistence mechanism considering directional transmission/reception. Said procedures may be implemented by apparatus, systems, methods, or computer program products.

One method of a User Equipment (“UE”) for non-LBT based fair coexistence includes receiving a measurement configuration from a network node indicating a measurement resource and time window for performing interference measurement and configuring a zero-power channel state information reference signal (“ZP-CSI-RS”) for performing long-term interference measurement according to the measurement configuration. The method includes performing detection activity, the detection activity includes at least one of: A) performing an interference measurement on a plurality of beams within a configured time window using the configured measurement resource; and B) receiving acknowledgment feedback from the network node for intra-network transmission. The method includes determining an interference amount based on the detection activity (e.g., the interference measurement and/or the acknowledgment feedback) and adjusting a UE transmission power for an uplink (“UL”) physical channel transmission based on the determined amount of interference.

One method of a Radio Access Network (“RAN”) for non-LBT based fair coexistence includes transmitting a measurement configuration to a UE, the configuration indicating a measurement resource for performing interference measurement. The method includes transmitting acknowledgment feedback to the UE for intra-network transmission and receiving an uplink transmission from the UE, where the UE adjusts its transmission power for an UL physical channel transmission based on an interference amount determined based on at least one of the interference measurement and the acknowledgment feedback.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for non-LBT based fair coexistence;

FIG. 2 is a block diagram illustrating one embodiment of a Fifth-Generation (“5G”) New Radio (“NR”) protocol stack;

FIG. 3 is a call-flow diagram illustrating one embodiment of transmitter adjustment based on long-term interference measurements;

FIG. 4 is call-flow diagram illustrating one embodiment of transmitter adjustment based on consecutive reception of NACK/DTX;

FIG. 5 call-flow diagram illustrating one embodiment of transmitter adjustment based on consecutive failure to receive RAR;

FIG. 6 call-flow diagram illustrating one embodiment of transmitter adjustment based on consecutive SR failure;

FIG. 7 is a block diagram illustrating one embodiment of a user equipment apparatus that may be used for non-LBT based fair coexistence;

FIG. 8 is a block diagram illustrating one embodiment of a network apparatus that may be used for non-LBT based fair coexistence;

FIG. 9 is a flowchart diagram illustrating one embodiment of a first method for non-LBT based fair coexistence; and

FIG. 10 is a flowchart diagram illustrating one embodiment of a second method for non-LBT based fair coexistence.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for non-LBT based fair coexistence. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Currently for sub-6 GHz New Radio (“NR”) operation on unlicensed spectrum (referred to as “NR-U”), only short-term channel sensing in the form of omni-directional Listen-Before Talk (“LBT”) is supported. However, in the on-going study on beyond 52.6 GHz (i.e., “B52.6 GHz”), unlicensed channel access at 60 GHz is being discussed and it has been agreed that both LBT and no-LBT based unlicensed channel access mechanism will be supported in NR Rel-17. Moreover, directional (beam-based) channel access is also considered that would require sensing channels in different beam directions. The main purpose of channel sensing is two-fold, i.e., to protect the on-going transmissions from being interfered by the intended transmission and protect the intended transmission from being interfered by the on-going transmission.

Therefore, long-term sensing is important for unlicensed access. This disclosure provides solutions on how to uplink transmissions for fair coexistence with other systems, where the UE identifies potential interference from those other systems such as Wi-Fi/WiGig and adjusts transmitter power and beams accordingly.

As mobile communication networks operate in frequency ranges above 52.6 GHz, changes are required to adapt NR waveform and radio access technologies to support operation at the higher frequencies (e.g., between 52.6 GHz and 71 GHz). Further, operation on shared (i.e., unlicensed) spectrum channel sensing is required and there is potential interference with other nodes also operating on the same shared spectrum band(s).

In particular, a study item for 3GPP NR is to evaluate the channel access mechanism in frequency ranges above 52.6 GHz, considering potential interference to/from other nodes, assuming beam-based operation, in order to comply with the regulatory requirements applicable to unlicensed spectrum for frequencies between 52.6 GHz and 71 GHz. Regarding physical layer procedures, the channel access mechanism may assume beam-based operation for frequency ranges above 52.6 GHz, in order to comply with regulatory requirements applicable to unlicensed spectrum for frequencies between 52.6 GHz and 71 GHz.

For a gNB (i.e., 5th generation base station) and/or UE to initiate a channel occupancy, both channel access with LBT mechanism(s) and a channel access mechanism without LBT are supported. In certain embodiments, operation restrictions for channel access without LBT are needed, e.g., compliance with regulations, and/or in presence of Automatic Transmit Power Control (“ATPC”), Dynamic Frequency Selection (“DFS”), long-term sensing, or other interference mitigation mechanisms.

ATPC and DFS may be used to support no-LBT based inter-system coexistence. With ATPC a transmitter adjusts its transmit power through closed-loop feedback from receiver to the minimum necessary to operate a link with desired performance, in order to minimize self-interference. However, ATPC mechanisms do not take into account external interference (i.e., inter-system or inter-network interference), nor do ATPC mechanisms consider long-term channel sensing information. With DFS, a transmitter may dynamically switch the channel of operation based on channel congestion. However, DFS mechanisms do not take into account levels of inter-system or inter-network interference, nor do DFS mechanisms consider long-term channel sensing information.

Disclosed are procedures for non-LBT based fair coexistence mechanism considering directional transmission/reception. Among the novel concepts disclosed herein is a two-step process of firstly, detecting an interference condition and secondly, the process of adjusting one or more transmitter parameters of the UL physical channels based on the measured interference level.

Regarding interference detection, according to a first detection option the interference condition may be detected by measuring long-term interference. According to a second detection option the interference condition may be detected using a consecutive NACK/DTX-based counter mechanism may be used to detect a consistent interferer. Alternatively, the UE may count the consecutive failures of Random-Access Response (“RAR”) within the ra-ResponseWindow, or consecutive failed Scheduling Request (“SR”), to detect the interference condition.

Regarding transmitter adjustment after detecting the interference condition, according to a first adjustment option the instantaneous calculated total transmission power of the UL physical channel transmission is reduced so that the actual transmission power of the UE does not exceed configured maximum transmit power. Alternatively, the maximum transmit power of the UL physical channels may be reduced based on the measured interference level.

In one embodiment, a mapping table containing information about the maximum P0 nominal power of PUSCH/PUCCH or PCMAX value is used by a UE for a range of measured interference level. In another embodiment, a mapping table containing information about the maximum P0 nominal power for Physical Random Access Channel (“PRACH”) transmission is used by a UE based on the measured interference level.

According to a second adjustment option, instead of reducing the transmit power of the UL physical channels the UE switches the beam/panel and/or active UL Bandwidth Part (“BWP”) based on the consistent failures due to an interferer.

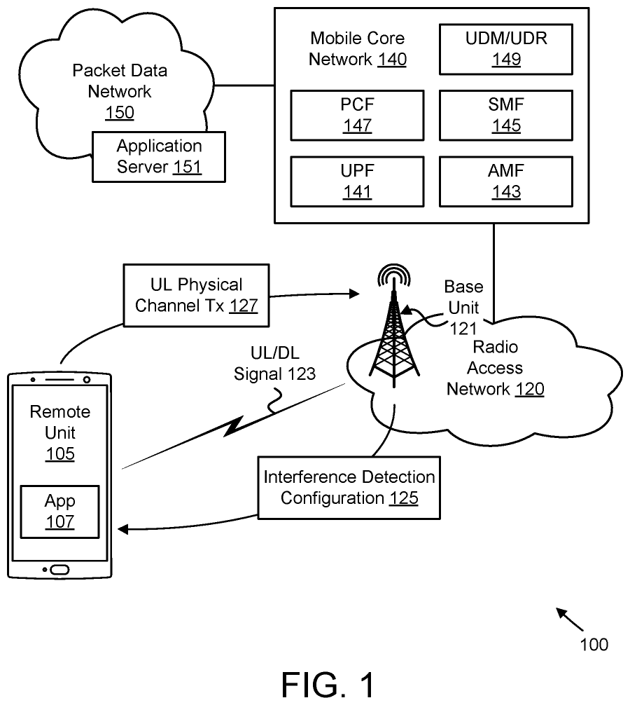

FIG. 1 depicts a wireless communication system 100 for non-LBT based fair coexistence, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM””) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for non-LBT based fair coexistence apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In various embodiments, the remote unit 105 receives an interference detection configuration 125 from the base unit 121. In certain embodiments, the interference detection configuration may include an interference measurement configuration, for example containing a ZP-CSI-RS and/or ZP-CSI-IM resource, a time window, an interference threshold, a set of beams to monitor, and/or other parameters for measuring inter-network and/or inter-system interference. In certain embodiments, the interference detection configuration may include a reception feedback configuration, for example containing one or more counters, a maximum counter value (i.e., threshold), and/or other parameters for detecting a consistent interferer from data reception statistics.

In certain embodiments, the interference detection configuration also includes an adjustment configuration that indicates how to adjust the remote unit 105 is to adjust its transmitter based on the measured interference level and/or the detected presence of a consistent interferer. For example, the adjustment configuration may indicate to reduce a transmission power of the remote unit 105. As another example, the adjustment configuration may indicate to increase a number of repetitions (e.g., maximum number of retransmissions) for Physical Uplink Control Channel (“PUCCH”) and/or Physical Uplink Shared Channel (“PUSCH”) transmissions. In yet another example, the adjustment configuration may indicate to switch a transmit beam (or panel) and/or to switch an active bandwidth part. The remote unit 105 then sends a UL physical channel transmission 127 using the adjusted parameters.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for non-LBT based fair coexistence.

In some of the embodiments described, an antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

Two antenna ports may be quasi-located with respect to a subset of the large-scale properties and different subset of large-scale properties may be indicated by a Quasi-Co-Location (“QCL”) Type. For example, the parameter ‘qcl-Type’ may take one of the following values:
‘QCL Type-A’: {Doppler shift, Doppler spread, average delay, delay spread}
‘QCL Type-B’: {Doppler shift, Doppler spread}
‘QCL Type-C’: {Doppler shift, average delay}
‘QCL Type-D’: {Spatial Rx parameter}.

Spatial Rx parameters may include one or more of: Angle of Arrival (“AoA”), Dominant AoA, average AoA, angular spread, Power Angular Spectrum (“PAS”) of AoA, average Angle of Departure (“AoD”), PAS of AoD, transmit/receive channel correlation, transmit/receive beamforming, spatial channel correlation etc.

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (“CDD”). The procedure used to derive antenna ports from physical antennas may be specific to a device implementation and transparent to other devices.

In some of the embodiments described, a Transmission Configuration Indicator (“TCI”) state associated with a target transmission can indicate parameters for configuring a quasi-collocation relationship between the target transmission (e.g., target RS of Demodulation Reference Signal (“DM-RS”) ports of the target transmission during a transmission occasion) and a source reference signal(s) (e.g., Synchronization Signal Block (“SSB”), Channel State Interference Reference Signal (“CSI-RS”) and/or Sounding Reference Signal (“SRS”)) with respect to QCL type parameter(s) indicated in the corresponding TCI state. A device can receive a configuration of a plurality of transmission configuration indicator states for a serving cell for transmissions on the serving cell.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter/beam used for reception the reference RS (e.g., DL RS such as SSB and/or CSI-RS). In another example, the device may transmit the target transmission with the same spatial domain transmission filter/beam used for the transmission of the reference RS (e.g., UL RS such as SRS). A device can receive a configuration of a plurality of spatial relation information configurations for a serving cell for transmissions on the serving cell.

Throughout the different embodiments of the disclosure, the term quasi co-location—and quasi co-located—is to be understood mainly in the terms of transmit/receive beamforming and spatial channel correlation, but should not be limited thereto.

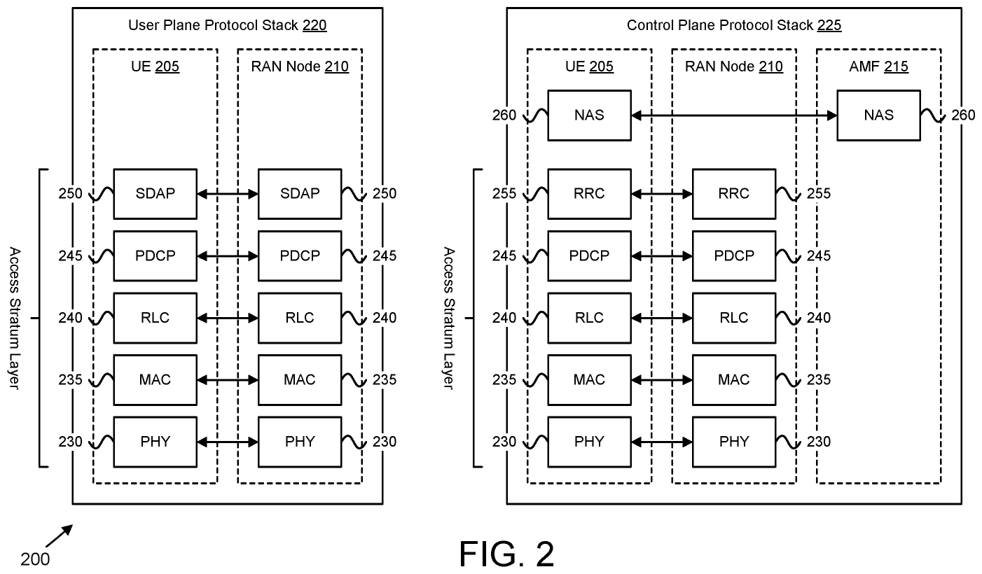

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 220 and a Control Plane protocol stack 225. The User Plane protocol stack 220 includes a physical (“PHY”) layer 230, a Medium Access Control (“MAC”) sublayer 235, the Radio Link Control (“RLC”) sublayer 240, a Packet Data Convergence Protocol (“PDCP”) sublayer 245, and Service Data Adaptation Protocol (“SDAP”) layer 250. The Control Plane protocol stack 225 includes a physical layer 230, a MAC sublayer 235, a RLC sublayer 240, and a PDCP sublayer 245. The Control Plane protocol stack 225 also includes a Radio Resource Control (“RRC”) layer 255 and a Non-Access Stratum (“NAS”) layer 260.

The AS layer (also referred to as “AS protocol stack”) for the User Plane protocol stack 220 consists of at least SDAP, PDCP, RLC and MAC sublayers, and the physical layer. The AS layer for the Control Plane protocol stack 225 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 255 and the NAS layer 260 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 230 offers transport channels to the MAC sublayer 235. The physical layer 230 may perform a Clear Channel Assessment and/or Listen-Before-Talk (“CCA/LBT”) procedure using energy detection thresholds, as described herein. In certain embodiments, the physical layer 230 may send a notification of UL Listen-Before-Talk (“LBT”) failure to a MAC entity at the MAC sublayer 235. The MAC sublayer 235 offers logical channels to the RLC sublayer 240. The RLC sublayer 240 offers RLC channels to the PDCP sublayer 245. The PDCP sublayer 245 offers radio bearers to the SDAP sublayer 250 and/or RRC layer 255. The SDAP sublayer 250 offers QoS flows to the core network (e.g., 5GC). The RRC layer 255 provides for the addition, modification, and release of Carrier Aggregation and/or Dual Connectivity. The RRC layer 255 also manages the establishment, configuration, maintenance, and release of Signaling Radio Bearers (“SRBs”) and Data Radio Bearers (“DRBs”).

The NAS layer 260 is between the UE 205 and the 5GC (i.e., AMF 215). NAS messages are passed transparently through the RAN. The NAS layer 260 is used to manage the establishment of communication sessions and for maintaining continuous communications with the UE 205 as it moves between different cells of the RAN. In contrast, the AS layer is between the UE 205 and the RAN (i.e., RAN node 210) and carries information over the wireless portion of the network.

Disclosed herein are transmitter adjustment mechanisms for unlicensed bands without LBT by utilizing implicit and/or explicit measurement of interference from other systems such as Wi-Fi/WiGig and/or other NR operators and applying the detected/measured/interpreted interference to either one or a combination of following the following adjustments:

First, transmit power adaptation at the transmitter based on aforementioned interference in addition to other factors such as path loss, maximum transmit power control, etc. For example, if higher interference is detected by UE, then UE can assume that there is on-going transmission/reception from other systems and/or operators and accordingly reduce its transmit power to reduce the potential interference to other systems, while at the same time, maintaining minimum required transmit power.

Second, updating the transmit frequency resources, such as BWP based on aforementioned interference. For example, if the UE experiences the interference above a certain threshold on the current active BWP, then UE can indicate other potential BWP where possibly there is no interference or below certain threshold.

Beneficially, the disclosed schemes use the interference measurement to minimize the interference to the other Wi-Fi/WiGig/NR-U system for having fair coexistence thereby reducing the maximum transmit power for each of the beam/panel for an active UL BWP and/or indicating new BWP where potentially lower interference is expected.

According to embodiments of a first solution, the UE 205 is configured to adapt its UL transmit power control, e.g., for UL physical channels, upon detecting an interference condition, such as a measured interference level exceeding a threshold and/or detecting a consistent interferer from data reception statistics/feedback.

One benefit is to allow the UE 205 to measure interference and/or other channel characteristics from other systems outside of NR and/or other networks and without the need to transmit any signals and channels from any nodes within the same system, so that fair co-existence with other systems or other networks can be better ensured.

According to a first detection option of the first embodiment, the UE 205 is configured to measure interference from other Wi-Fi/WiGig/NR-U system operating at the same carrier frequency in the 60 GHz range. Upon the measured interference level exceeding a certain configured threshold, then the UE 205 adapts its UL transmit power control, e.g., for UL physical channels based on the measured interference level. In certain embodiments, the configured threshold is signaled by RAN node 210.

In some embodiments, the UE 205 performs configuration of a ZP-CSI-IM resource for interference measurement from plurality of beams as described in International Patent Application Number PCT/IB2021/058381 entitled “CHANNEL-SENSING MEASUREMENT AND CHANNEL ACCESS REPORT” and filed on 14 Sep. 2021 for Ankit Bhamri, Karthikeyan Ganesan, Alexander Johann Maria Golitschek Edler von Elbwart, Ali Ramadan Ali, and Vijay Nangia, and in U.S. Provisional Patent Application 63/078,294, titled “REFERENCE SIGNAL AND REPORTING FOR LONG-TERM SENSING FOR UNLICENSED CHANNEL ACCESS” and filed on 14 Sep. 2020 for Ankit Bhamri, Karthikeyan Ganesan, Alexander Johann Maria Golitschek Edler von Elbwart, Ali Ramadan Ali, and Vijay Nangia.

In certain embodiments, the UE 205 may be configured by the network (i.e., by the RAN node 210) with measurement resources at regular intervals of time and QCL assumption Type-D or TCI state, where the UE 205 is not expected to receive/transmit any channels and signals from any node within the same network (including gNBs, Transmission-Reception Points (“TRPs”), and/or other UEs). In this scenario, the UE 205 may be configured with resources to measure inter-system interference primarily by ensuring that the UE 205 is not expected to be configured/scheduled with any channels/signals within the same network. Specifically, the UE 205 does not use the measurement resources (i.e., does not transmit signals on the measurement resources and is not expected to receive signals on the measurement resources). Additionally, the network does not use the measurement resources (i.e., does not transmit signals on the measurement resources and is not expected to receive signals on the measurement resources).

In one implementation, the UE 205 is semi-statically configured by the RAN node 210 via UE-specific RRC signaling with one or more periodic resources in terms of at least one or more of the following parameters, including: periodicity, time offset, QCL assumption Type-D, time symbols, frequency resources, measurement quantities, reporting resources. Once the UE 205 receives the RRC configuration, the UE 205 is expected to perform measurements as long as the UE 205 is not configured with release or deactivation of the periodic configured measurement resources, e.g., either semi-statically by RRC or dynamic signaling via MAC Control Element (“CE”) or Downlink Control Information (“DCI”). In one example, the QCL assumption Type-D is indicated dynamically via MAC CE or DCI.

In another implementation, the UE 205 is configured with a periodic Zero-Power Channel State Information Reference Signal (“ZP-CSI-RS”) or alternatively, a zero-power Channel State Information-Interference Measurement (“ZP-CSI-IM”) may be configured for inter-system interference measurements, where the UE 205 is not expected to receive/transmit any signals and channels from any nodes within the network in the specific Rx beam direction at the UE 205 on the configured measurement resources.

In one embodiment, the UE 205 may be semi-statically configured by the RAN node 210 via UE-specific RRC signaling with one or more semi-persistent measurement resources in terms of at least one or more of the following parameters, including: periodicity, time offset, QCL assumption Type-D, time symbols, frequency resources, measurement quantities, reporting resources. Once the UE 205 receives the UE-specific RRC configuration and receives activation via MAC CE or DCI, then only the signaled UE 205 is expected to perform measurements. The UE 205 will stop measurements once the UE 205 is indicated semi-statically by RRC or dynamic signaling via MAC CE or DCI to deactivate the semi-persistent configured measurement resources. In one example, the QCL assumption Type-D is indicated dynamically via MAC CE or DCI. In the above embodiments, the UE 205 may be configured with measurement resources over the entire frequency/bandwidth. In certain embodiments, the UE 205 may be configured with one or more bandwidth parts (“BWPs”). Here, the UE 205 may be configured with measurement resources over the entire configured BWP (e.g., an active configured BWP). Alternatively, the UE may be configured with one or more measurement resources on an inactive configured BWP to reduce intra-network interference or self-interference.

In an alternate embodiment, the network transmits a common configuration to a group of UEs for measurement resource configuration. Here, the UE 205 may be semi-statically configured by the RAN node 210 via common RRC signaling with one or more periodic measurement resources in terms of at least one or more of the following parameters including periodicity, time offset, QCL assumption Type-D, time symbols, frequency resources, measurement quantities. In this embodiment, all the UEs 205 that receive the common RRC configuration are expected to perform measurements as long as the UE is not configured with release or deactivation of the periodic configured measurement resources, e.g., either semi-statically by RRC or dynamic signaling via MAC CE or group-common DCI.

In one implementation of the alternate embodiment, UE 205 is semi-statically configured by the RAN node 210 via common RRC signaling with one or more semi-persistent measurement resource in terms of at least one or more of the following parameters including periodicity, time offset, QCL assumption Type-D, time symbols, frequency resources, measurement quantities. Once the UE 205 receives the common RRC configuration and receives activation via MAC CE or group common DCI, then only the receiving UE 205 is expected to perform measurements. In one implementation, the UE 205 will stop measurements once the UE 205 is indicated semi-statically by RRC or dynamic signaling via MAC CE or group-common DCI to deactivate the semi-persistent configured measurement resources.

In one another implementation of the first detection option, periodic measurement gap duration may be semi-statically configured by the RAN node 210 to measure the wideband energy Received Signal Strength Indicator (“RSSI”) in an active BWP and dormant BWPs from plurality of active set of beams/panels in each of the configured carrier as a method of detecting interference from other system. The measurement gap duration can be configurable while the RAN node 210 and UEs are not expected to receive/transmit any channels during the measurement gap duration.

Here, the UE 205 is configured with the time window for the interference averaging where the wideband interference measured during the measurement gap could be averaged as part of generating long-term interference statistics. The interference statistics may be maintained at the UE 205 per beams/panels of an active carrier/BWP and dormant carrier/BWP. Averaged interference measurement obtained from the periodic measurement may then be used as an input for the adaptive transmit power control loop for transmission of UL physical channels, discussed below.

In another implementation of the first detection option, an aperiodic measurement gap duration (including the starting and length in duration i.e., microsecond, millisecond, symbols, slots) can be signaled to the UE 205, e.g., using RRC signaling, MAC CE, DCI. The RAN node 210 may configure aperiodic measurement gap for plurality of beams/panel of an active UL BWP. Further, instantaneous interference measurement(s) obtained from the aperiodic measurement gap may also be used for the adaptive transmit power control loop.

In various embodiments of the first solution, the instantaneous calculated total transmission power of the UL physical channel transmission is reduced so that the actual transmission power of the UE 205 does not exceed configured maximum transmit power. Further, the maximum transmit power of the UL physical channels may be reduced based on the measured interference level.

In some embodiments, the duration of the adjusted/reduced maximum transmit power of UL physical channels may be semi-statically configured or defined using the set of periodic detection and measurement of interference levels. In one implementation, the duration of UL transmit power reduction of physical channels may be based on the next detection and measurement of interference level by the UE 205, e.g., the next measurement gap or the next interference averaging point. Here, the UE 205 periodically adjusts its maximum transmit power using the interference measurements.

In one implementation of the first detection option, the RAN node 210 may transmit a set of mapping table containing mapping of interference level to the maximum transmit power of a UE for each UL physical channels. This mapping table could be signaled per physical channel could be periodically broadcasted using system information block or could be configured by RRC dedicated signaling.

In one example, mapping table may contain information about the maximum P0 nominal power of PUSCH to be used by a UE 205 for a range of measured interference level. In another example, the mapping table may contain information about the PCMAX of PUSCH to be used by the UE 205 for a range of measured interference level.

In another implementation, the UL power control equation of PUSCH can be modified by introducing a new factor by considering the interference level measurement. As an example, {gamma×interference level} could be added to the PUSCH power control equation (as shown below) where gamma “γ” determines factor of measured interference level to be used for the uplink transmit power control, e.g., according to the following equations.

$$\\ \begin{matrix}{P}_{PUSCH , b , f , c} ( i , j , q , l ) = min \{ \begin{matrix}A \\ B\end{matrix} \} [ dBm ] , where & Equation 1\end{matrix}$$

$$\\ \begin{matrix}A = {P}_{CMAX , f , c} ( i ) \cdot ( γ \times Interference\_Level ) and & Equation 1 A\end{matrix}$$

$$\\ \begin{matrix}B = {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) & Equation 1 B\end{matrix}$$

In Equation 1A, gamma value may be configured (i.e., by the network) between 0 and 1 (including fractional values). The other factors in Equations 1, 1A, and 1B are defined in 3GPP Technical Specification (“TS”) 38.213. Transmit power control can be independently performed based on the interference measurement from each of the beam/panel for an active UL BWP and in another method, maximum transmit power could be independently configured for each of the beam/panel based on the interference level measured from each of the beam/panel for an active UL BWP. The transmit power control may be applied for both dynamic grant and configured grant. In certain embodiments, the value of the P0 nominal power is independently configured for dynamic grant and configured grant, where configured grant parameter could additionally include the gamma factor.

When implementing UL transmit power control for random access procedure, a maximum preamble transmit power could be similarly adjusted by the UE 205 based on the interference level, where the UE 205 ensures that the Random Access Channel (“RACH”) power ramping procedure does not exceed the maximum preamble transmit power. Note that the adjustment values may be provided to the UE 205 form the RAN node 210, as described above for the case of PUSCH transmission. In another implementation, for Type-2 random access procedure (i.e., two-step RACH procedure), the maximum P0 nominal power limitation includes both the preamble transmit power and MsgA PUSCH transmit power.

In another implementation, a maximum PUCCH transmission power could be similarly adjusted by the UE 205 according to the interference level by configuring either PCMAX or P0 nominal power for PUCCH. In certain embodiments, the maximum p0-PUCCH-Value could be configured for each of the PUCCH-SpatialRelationInfo. In another implementation, the UL power control equation of PUCCH can be modified by introducing a new factor by considering the interference level measurement. As an example, {gamma×interference level} could be added to the PUCCH equation (as shown below) where gamma determines factor of interference level to be used for the uplink transmit power control, e.g., according to the following equations.

$$\\ \begin{matrix}{P}_{PUCCH , b , f , c} ( i , j , q , l ) = min \{ \begin{matrix}A \\ B\end{matrix} \} [ dBm ] , where & Equation 2\end{matrix}$$

$$\\ \begin{matrix}A = {P}_{CMAX , f , c} ( i ) \cdot ( γ \times Interference\_Level ) and & Equation 2 A\end{matrix}$$

$$\\ \begin{matrix}B = {P}_{O \_ PUCCH , b , f , c} ( {q}_{u} ) + 10 {log}_{10} ( {2}^{μ} \cdot {M}_{RB , b , f , c}^{PUSCH} ( i ) ) + {PL}_{b , f , c} ( {q}_{d} ) + {Δ}_{F \_ PUCCH} ( F ) + {Δ}_{TF , b , f , c} ( i ) + {g}_{b , f , c} ( i , l ) & Equation 2 B\end{matrix}$$

In Equation 2A, the gamma value may be configured (i.e., by the network) between 0 and 1 (including fractional values). The other factors in Equations 2, 2A, and 2B are defined in 3GPP TS 38.213. In the above embodiments, the UL transmit power is reduced based the detected/measured/interpreted interference above certain threshold. However, based on subsequent measurements of interference, if the interference level from other systems and/or operators drops below a certain threshold again, then the UL transmit power can be increased and the interference factor from power control equation can be disregarded.

According to a second detection option of the first embodiment, the UE 205 performs interference detection using explicit feedback that provides additional information about the data reception statistics at the receiver side (i.e., at the RAN node 210), which could be helpful for the transmitter (i.e., UE 205) to adapt the transmit power control according to the measured interference level as described above. Because the reduction of the maximum transmit power could affect the reliability of the packet reception; further repetitions could be configured at the UE side. Here, the number of repetitions for PUSCH and/or PUCCH could be a factor of interference level which could be signaled to the UE 205, e.g., as part of RRC signaling.

In one implementation of the second detection option, the presence of a consistent interferer is determined from consecutive NACKs reception from the RAN node 210, e.g., after the transmission of PUSCH. Here, the UE 205 may maintain a counter for interference detection, where the counter is initially set to zero. Upon receiving NACK (or DTX) from the transmission of PUSCH, the UE 205 could then increment the counter. Subsequently, the UE 205 may reset the counter to zero after receiving an ACK from the RAN node 210 for the transmission of PUSCH. In certain embodiments, the UE 205 is configured with a (configurable) maximum counter value, which could be the threshold for detecting a consistent interferer. In various embodiments, a NACK-based counter is maintained for each Transmit (“Tx”) spatial filter, or beam, or panel, or spatial setting, or spatial relation, or TCI state for which Hybrid Automatic Repeat Request (“HARQ”) reporting is generated.

In another implementation of the second detection option, the presence of a consistent interferer is determined from consecutive DTX from the RAN node 210, e.g., after the transmission of PUSCH. Here, the UE 205 may maintain a counter for interference detection, where the counter is initially set to zero and is incremented upon detecting DTX. Subsequently, the UE 205 may reset the counter to zero after receiving an ACK from the RAN node 210 for the transmission of PUSCH. In certain embodiments, the UE 205 is configured with a (configurable) maximum number of DL consecutive DTX, which could be the threshold for detecting a consistent interferer. In various embodiments, a DTX-based counter is maintained for each Tx spatial filter, or beam, or panel, or spatial setting, or spatial relation, or TCI state for which HARQ reporting is generated. Note that a NACK-based counter and a separate DTX-based counter may be maintained for the same TX filter/beam/panel/etc.

In another implementation of the second detection option, a UE 205 may determine the presence of a consistent interferer from missed Random-Access Response (“RAR”). After the transmission of the Random Access preamble (i.e., PRACH preamble) waits for a RAR from the RAN node 210 within the configured RACH Response Window. When the UE 205 does not receive a RAR within the configured RACH Response Window, it performs power ramping procedure according to 38.321.

Moreover, the UE 205 maintains a counter for consecutive failures of Random-Access Response within the RACH Response Window, where the counter can be initially set to zero and it is incremented each time when the UE 205 fails to receive a RAR from the RAN node 210 within the configured RACH Response Window. The UE 205 compares the counter value against a configurable maximum counter value for detecting interference; the counter is reset to zero when the UE 205 successfully receives RAR from the RAN node 210 within the configured RACH Response Window.

In another implementation, the UE 205 may track an amount of consecutive failures of UL grant reception after the transmission of a Scheduling Request (“SR”) as another indication of interference detection. In such embodiments, the UE 205 transmits first SR when data arrives at its buffer and expect UL Grant from gNB for PUSCH transmission. The UE 205 may transmit a second SR after the expiration of SR prohibit timer when the UE 205 fails to receive an UL grant from the RAN node 210.

In various embodiments of the second detection option, interference detection may be performed independently for various beams/panels in an active BWP, or dormant BWP, for a plurality of carriers.

According to embodiments of a second solution, the UE 205 is configured to adapt its UL transmit frequency resources, e.g., for transmit beam/panel and/or active UL BWP, upon detecting an interference condition, such as a measured interference level exceeding a threshold (i.e., first detection option) and/or detecting a consistent interferer from data reception statistics/feedback (i.e., second detection option). For example, if the UE experiences the interference above a certain threshold on the current active BWP, then UE can indicate other potential BWP where possibly there is no interference or below certain threshold.

In some embodiments of the second solution, a UE 205 periodically performs interference level measurement on an active UL BWP, e.g., using a plurality of beams/panels. Here, the averaged interference measurement values—or instantaneous interference measurement value—can be compared against a (pre)-configured threshold which is signaled by the RAN node 210. In such embodiments, the UE 205 adapts its UL transmit frequency resources when the measured interference level exceeds the threshold. The interference measurement with different implementations is explained above with reference to the first detection option.

In some embodiments of the second solution, a UE 205 periodically performs interference detection based on consecutive NACK/DTX count, consecutive missed RAR, and/or consecutive failed SR. Here, if the counter for interference detection exceeds a configured number of times for a specific beam/panel of an active UL BWP, then the UE 205 adapts its UL transmit frequency resources. The interference detection with different implementations is explained above with reference to the second detection option.

In some embodiments of the second solution, the UE 205 may autonomously deactivate a specific beam/panel for that active UL BWP upon detecting an interference condition. In certain embodiments, the UE 205 may ignore the beam-specific information signaled in a DCI/UL grant and autonomously select a different beam/panel for corresponding UL transmission for that active UL BWP (e.g., from the set of configured and active beams/panels).

Moreover, upon autonomous deactivation of a beam/panel, the UE 205 may autonomously activate another beam/panel (i.e., the selected beam/panel) and perform Random Access Procedure (also referred to as RACH procedure) using the newly activated beam/panel. Alternatively, the UE 205 may inform the RAN 210 about the newly activated beam/panel for that active UL BWP.

In an alternative implementation of the second solution, the order of the BWPs/beams to be switched on may be signaled to the UE 205. In such embodiments, the RAN node 210 expects the UL transmission at a certain BWP/beam upon the NACK/DTX counting points.

In another implementation of the second solution, when interference level is above the preconfigured threshold and/or interference detection based on consecutive NACK/DTX exceeds configured number of times for a specific UL BWP using a specific beam/panel, the UE 205 may autonomously switch its UL BWP, i.e., deactivate a current UL BWP while activating a new UL BWP.

In another implementation of the second solution, the UE 205 may perform switching from active UL BWP to another UL BWP in the serving cell (where the interference measurement is below threshold) by performing RACH procedure/SR procedure using the same beam/panel; otherwise, the UE 205 may inform the RAN node 210 about the newly activated UL BWP.

According to embodiments of a third solution, both UL transmit power and frequency resource adaptation may be performed in response to detecting an interference condition while operating on shared spectrum. In some embodiments, the channel access mechanism on shared spectrum follows a sequential procedure comprising of:

Step 1: The UE 205 performs transmit power adaptation/reduction based on measured/detected interference on a given beam on an active BWP. If the transmit power needs to be reduced below the minimum required level, then Step 2 is performed.

Step 2: The UE 205 performs transmit beam/panel adaptation based on the measured/detected interference. Here, the given beam is deactivated, and the next available beam is accessed, where the potential interference from other systems and/or operators on the next beam is below a certain threshold. However, if no such beam is available on the current active BWP, then Step 3 is performed.

Step 3: The UE 205 switches the UL BWP by deactivating the active BWP and activating a different one of the configured BWPs, where the expected interference on at least one beam of the new BWP is below a certain threshold. If interference is detected on the new BWP, then Steps 1-2 can be similarly followed as for previous active BWP.

In other embodiments, a different sequence of steps 1, 2 and 3 may be implemented.

According to embodiments of a fourth solution, the interference measurement and detection method as explained in the above embodiments may be applied at the RAN node 210 for downlink transmission. Consequently, the RAN node 210 may adapt its transmitter parameters for a specific cell, sector, DL BWP, beam, etc. based on a detected interference condition and transmit a downlink physical channel transmission (e.g., Physical Downlink Control Channel (“PDCCH”), Physical Downlink Shared Channel (“PDSCH”), etc.) using the adapted transmitter parameters. One difference with the fourth solution is that the RAN node 210 may either measure interference through remote interference management (“RIM”) by configuring periodic Zero Power interference reference signal (e.g., ZP-CSI-IM) and number of NACKs/DTX from multiple UEs.

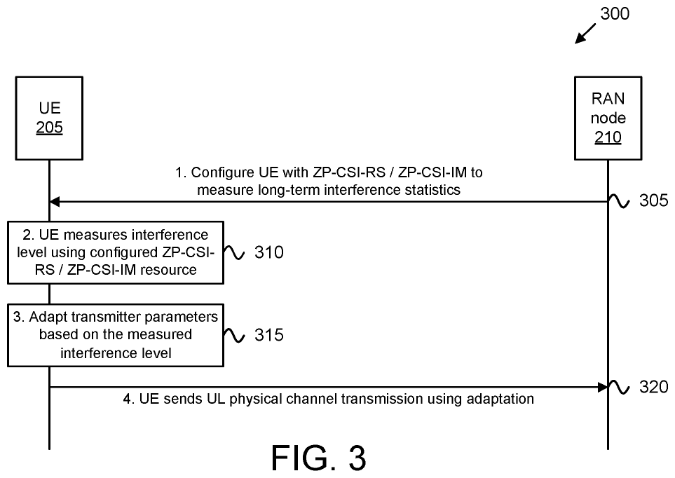

FIG. 3 depicts a procedure 300 for transmitter adjustment (i.e., transmit power and/or transmit frequency resource adaptation) based on long-term interference measurements, according to embodiments of the disclosure. The procedure 300 involves a UE 205 and a RAN node 210, such as a gNB. As noted above, the UE 205 may be one embodiment of the remote unit 105, while the RAN node 210 may be one embodiment of the base unit 121.

At Step 1, the RAN node 210 configures the UE 205 with resources to measure long-term interference statistics, such as ZP-CSI-RS and/or ZP-CSI-IM (see messaging 305). Here, the network (via RAN node 210) configures at least one resource (time-frequency resource grid) to the UE 205 and also configure a time window for the interference measurement(s).

At Step 2, the UE 205 measures interference, detect energy, etc. on the configured measurement resource (i.e., ZP-CSI-RS and/or ZP-CSI-IM) (see block 310). Here, the UE 205 is expected to measure interference, detect energy, etc. on the configured resource from the same systems (e.g., from other NR networks) or from other systems such as Wi-Fi/WiGig.

At Step 3, the UE 205 adapts transmitter parameters of its UL physical channels (see block 315). In some embodiments, the UE 205 reduces its UL transmitter power. In some embodiments, the UE 205 adapts its UL transmit frequency resources (i.e., beams and/or active BWP).

At Step 4, the UE 205 sends a UL physical channel transmission (e.g., PUSCH, PUCCH, PRACH preamble, SR) to the RAN node 210 using the adapted transmitter parameters.

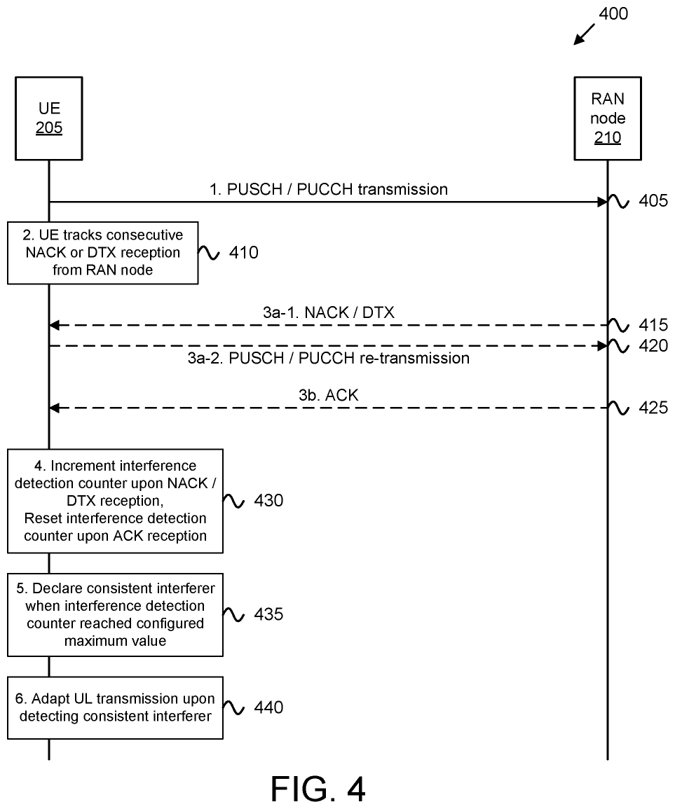

FIG. 4 depicts a procedure 400 for transmitter adjustment (i.e., transmit power and/or transmit frequency resource adaptation) based on consecutive reception of NACK/DTX, according to embodiments of the disclosure. The procedure 400 involves the UE 205 and the RAN node 210.

At Step 1, the UE 205 transmits PUSCH or PUCCH to the RAN node 210 (see messaging 405).

At Step 2, the UE 205 waits for HARQ feedback from the RAN node 210 and tracks the amount of consecutive NACK (and/or DTX) reception from the RAN node 210 (see block 410).

At Steps 3, the RAN node 210 sends HARQ feedback to the UE 205. As used herein, “HARQ-ACK/NACK” may represent collectively the Positive Acknowledge (“ACK”) and the Negative Acknowledge (“NACK”) and Discontinuous Transmission (“DTX”). ACK means that a Transport Block (“TB”) is correctly received while NACK (or “NAK”) means a TB is erroneously received and DTX means that no TB was detected.

For Steps 3a-1 and 3a-2, it is assumed that the RAN node 210 does not successfully receive the PUSCH/PUCCH transmission. At Step 3a-1, the RAN node 210 sends a NACK or DTX to the UE 205 (see messaging 415). At Step 3a-2, the UE 205 retransmits the PUSCH/PUCCH transmission (see messaging 420).

Alternatively, at Step 3b the RAN node 210 successfully receives the PUSCH/PUCCH transmission and thus sends an ACK to the UE 205 (see messaging 425).

At Step 4, the UE 205 increments the relevant interference detection counter upon NACK/DTX reception (see block 430). Alternatively, the UE 205 resets the relevant interference detection counter upon ACK reception.

At Step 5, the UE 205 declare consistent interferer when an interference detection counter reached its configured maximum value (see block 435).

At Step 6, the UE 205 adapts transmitter parameters of its UL physical channels in response to declaring/detecting a consistent interferer (see block 440). In some embodiments, the UE 205 reduces its UL transmitter power. In some embodiments, the UE 205 adapts its UL transmit frequency resources (i.e., beams and/or active BWP).

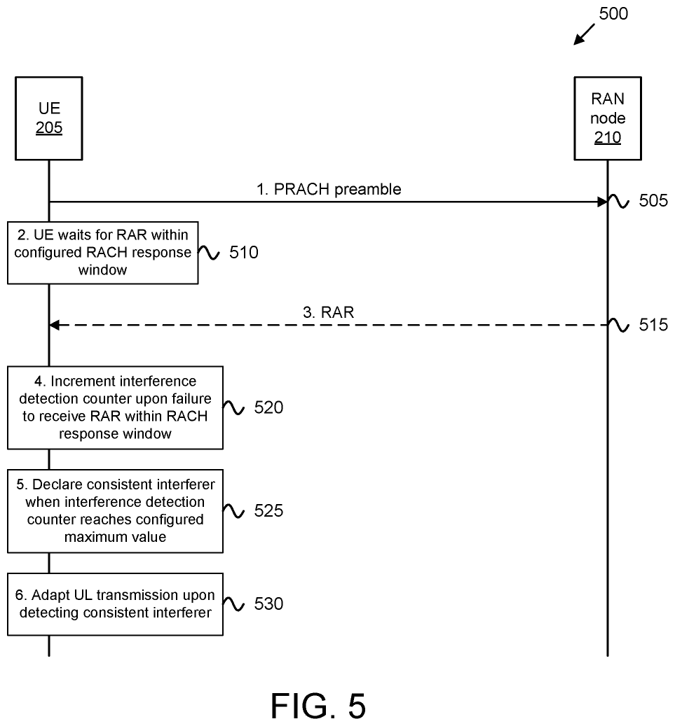

FIG. 5 depicts a procedure 500 for transmitter adjustment (i.e., transmit power and/or transmit frequency resource adaptation) based on consecutive reception of NACK/DTX, according to embodiments of the disclosure. The procedure 500 involves the UE 205 and the RAN node 210.

At Step 1, the UE 205 transmits a PRACH preamble to the RAN node 210 (see messaging 505).

At Step 2, the UE 205 waits for an uplink grant during a configured Random-Access response (“RACH response”) window (see block 510).

At Step 3, the RAN node 210 sends a RAR to the UE 205 if the PRACH preamble is successfully received at the RAN node 210 (see messaging 515). However, in the depicted scenario it is assumed that the RAN node 210 does not successfully receive the PRACH preamble.

At Step 4, the UE 205 increments a RAR-based interference detection counter upon failure to receive RAR during the configured RAN response window (see block 520). Alternatively, the UE 205 resets the interference detection counter upon RAR reception.

At Step 5, the UE 205 declare consistent interferer when the interference detection counter reached its configured maximum value (see block 525).

At Step 6, the UE 205 adapts transmitter parameters of its UL physical channels in response to declaring/detecting a consistent interferer (see block 530). In some embodiments, the UE 205 reduces its UL transmitter power. In some embodiments, the UE 205 adapts its UL transmit frequency resources (i.e., beams and/or active BWP).

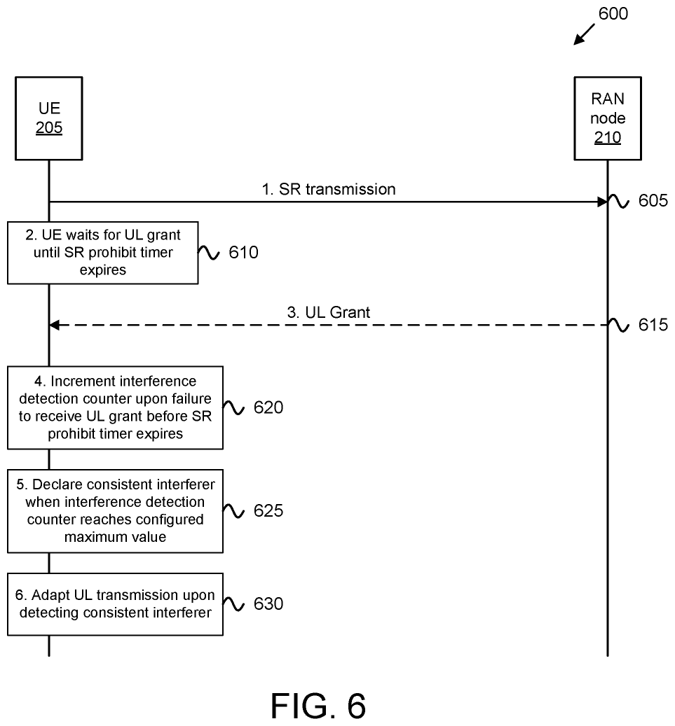

FIG. 6 depicts a procedure 600 for transmitter adjustment (i.e., transmit power and/or transmit frequency resource adaptation) based on consecutive reception of NACK/DTX, according to embodiments of the disclosure. The procedure 600 involves the UE 205 and the RAN node 210.

At Step 1, the UE 205 transmits a SR to the RAN node 210 (see messaging 605).

At Step 2, the UE 205 waits for an uplink grant until a SR prohibit timer expires (see block 610).

At Step 3, the RAN node 210 sends a UL grant to the UE 205 if the SR is successfully received at the RAN node 210 (see messaging 615). However, in the depicted scenario it is assumed that the RAN node 210 does not successfully receive the SR transmission.

At Step 4, the UE 205 increments a SR-based interference detection counter upon failure to receive a UL grant before the SR prohibit timer expires (see block 620). Alternatively, the UE 205 resets the interference detection counter upon receiving a UL grant.

At Step 5, the UE 205 declare consistent interferer when the interference detection counter reached its configured maximum value (see block 625).

At Step 6, the UE 205 adapts transmitter parameters of its UL physical channels in response to declaring/detecting a consistent interferer (see block 630). In some embodiments, the UE 205 reduces its UL transmitter power. In some embodiments, the UE 205 adapts its UL transmit frequency resources (i.e., beams and/or active BWP).

In some embodiments, the terms antenna, panel, and antenna panel are used interchangeably. An antenna panel may be a hardware that is used for transmitting and/or receiving radio signals at frequencies lower than 6 GHz, e.g., frequency range 1 (“FR1”), or higher than 6 GHz, e.g., frequency range 2 (“FR2”) or millimeter wave (mmWave). As used herein, FR1 refers to frequency bands from 410 MHz to 7125 MHz, FR2 refers to frequency bands from 24.25 GHz to 52.6 GHz, and mmWave refers generally to frequencies between 30 GHz and 300 GHz. In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device antenna panel (e.g., of a UE or RAN node) may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to the RAN node. For certain condition(s), the RAN node 210 can assume the mapping between device's physical antennas to the logical entity “device panel” may not be changed. For example, the condition may include until the next update or report from device or comprise a duration of time over which the RAN node assumes there will be no change to the mapping.

A Device may report its capability with respect to the “device panel” to the RAN node or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

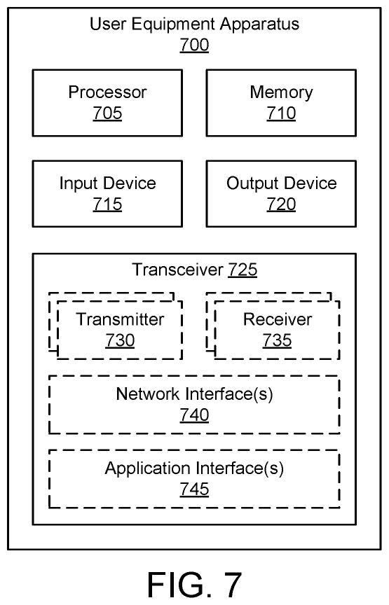

FIG. 7 depicts a user equipment apparatus 700 that may be used for non-LBT based fair coexistence, according to embodiments of the disclosure. In various embodiments, the user equipment apparatus 700 is used to implement one or more of the solutions described above. The user equipment apparatus 700 may be one embodiment of the remote unit 105 and/or the UE 205, described above. Furthermore, the user equipment apparatus 700 may include a processor 705, a memory 710, an input device 715, an output device 720, and a transceiver 725.

In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base units 121. In various embodiments, the transceiver 725 is operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the processor 705 controls the user equipment apparatus 700 to implement the above described UE behaviors. In certain embodiments, the processor 705 may include an application processor (also known as “main processor”) which manages application-domain and operating system (“OS”) functions and a baseband processor (also known as “baseband radio processor”) which manages radio functions.

In various embodiments, the processor 705 receives (i.e., via the transceiver 725 implementing an air interface) a measurement configuration from a network node (e.g., a RAN entity) indicating a measurement resource and time window for performing interference measurement. The processor 705 configures a zero-power channel state information reference signal (“ZP-CSI-RS”) for performing long-term interference measurement according to the measurement configuration. Here, the ZP-CSI-RS resource is a measurement resource where the UE does not transmit on the measurement resource, and where the network does not transmit on the measurement resource.

The processor 705 performs detection activity. Here, the detection activity includes at least one of: A) performing an interference measurement on a plurality of beams within a configured time window using the configured measurement resource; and B) receiving acknowledgment feedback from the network node (e.g., NACK or DTX or missed RAR) for intra-network (e.g., intra-cell) transmission. The processor 705 determines an interference amount based on the detection activity (e.g., the interference measurement and/or the acknowledgment feedback) and adjusts a UE transmission power for an uplink (“UL”) physical channel transmission based on the determined amount of interference.

In some embodiments, the measurement configuration indicates a threshold interference value. In such embodiments, the processor 705 adjusts the UE transmission power by reducing a maximum transmission power of the UL physical channel transmission in response to a measured interference level exceeding the threshold interference value, where a higher measured interference level causes a greater reduction of the maximum transmit power.

In some embodiments, the transceiver 725 further receives a configuration of gamma value factor for UL transmit power control. In such embodiments, the processor 705 adjusts the UE transmission power by determining the UL transmit power control by multiplying a PCMAX value by the gamma value and the measured interference value. As used herein, PCMAX is the maximum UE transmit power for the serving cell. In various embodiments, the processor 705 determines the UL transmit power control according to the UL transmit power control Equation 1 or Equation 2 using the gamma factor and the measured interference value.

In some embodiments, the transceiver 725 further receives a mapping table that maps a PCMAX value of a physical uplink channel (e.g., PUSCH) to be used by a UE for a range of measured interference level. In such embodiments, the processor 705 adjusts the UE transmission power by using the mapping table to adjust the maximum transmission power according to the measured interference level.

In some embodiments, the transceiver 725 further receives a mapping table that maps a maximum P0 nominal power of a physical uplink channel (e.g., PUSCH and/or PUCCH) to be used by a UE for a range of measured interference level. In such embodiments, the processor 705 adjusts the UE transmission power by using the mapping table to adjust the maximum P0 nominal power according to a measured interference level. As used herein, the P0 nominal power represents the target power level that the RAN entity/gNB wants to receive.

In some embodiments, the processor 705 tracks a number of consecutive NACK or DTX or missed RAR or SR failure. Here, the processor 705 reduces the UE transmission power when the number of consecutive NACK or DTX or missed RAR or SR failure exceeds a configured maximum counter value.

In certain embodiments, tracking the number of consecutive NACK or DTX or missed RAR or SR failure includes: A) initializing a counter value to zero; B) incrementing the counter value upon detecting a NACK or DTX or missed RAR or SR failure; C) comparing the counter value against the configured maximum counter value; and D) resetting the counter value to zero after the reception of ACK. As noted above, the processor 705 reduces the UE transmission power when the number of consecutive NACK or DTX or missed RAR or SR failure exceeds a configured maximum counter value.

In certain embodiments, the processor 705 further maintains a NACK-based counter for each transmit beam (e.g., each Tx spatial filter and/or beam and/or panel and/or spatial setting and/or spatial relation and/or TCI state) for which HARQ reporting is generated. In such embodiments, a particular NACK-based counter is incremented upon detecting a NACK for a corresponding transmit beam.

In certain embodiments, the processor 705 further maintains a DTX-based counter for each transmit beam (e.g., each Tx spatial filter/beam/panel/spatial setting/spatial relation/TCI state) for which HARQ ACK/NACK was not received. In such embodiments, a particular DTX-based counter is incremented upon detecting DTX for a corresponding transmit beam.

In certain embodiments, the processor 705 further maintains a RAR-based counter for consecutive failures of RAR within a configured RACH Response Window. In certain embodiments, the processor 705 further maintains a SR-based counter for consecutive failures of SR prior to expiration of SR prohibit timer.

In some embodiments, the processor 705 further switches a transmit beam in response to detecting a consistent interferer based on at least one of the interference measurement and the acknowledgment feedback. In some embodiments, the processor 705 further switches an active UL BWP transmit beam in response to detecting a consistent interferer based on at least one of the interference measurement and the acknowledgment feedback.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to non-LBT based fair coexistence and/or mobile operation. For example, the memory 710 may store various parameters, beam/panel configurations, resource assignments, policies, and the like as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit 121, such as the UL transmissions described herein. Similarly, one or more receivers 735 may be used to receive DL communication signals from the base unit 121, as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

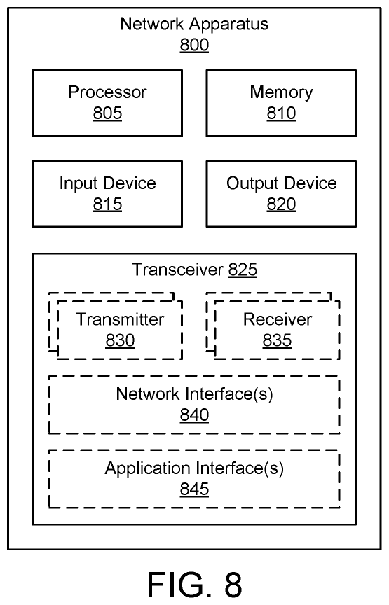

FIG. 8 depicts a network apparatus 800 that may be used for non-LBT based fair coexistence, according to embodiments of the disclosure. In one embodiment, network apparatus 800 may be one implementation of an evaluation device, such as the base unit 121 and/or the RAN node 210, as described above. Furthermore, the base network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs, as described herein. In such embodiments, the processor 805 controls the network apparatus 800 to perform the above described RAN behaviors. When operating as a RAN node, the processor 805 may include an application processor (also known as “main processor”) which manages application-domain and operating system (“OS”) functions and a baseband processor (also known as “baseband radio processor”) which manages radio functions.

In various embodiments, the processor 805 controls the transceiver 825 (i.e., implementing an air interface) to transmit a measurement configuration to a UE, the configuration indicating a measurement resource (e.g., ZP-CSI-RS) for performing interference measurement. The transceiver 825 transmits acknowledgment feedback to the UE (e.g., NACK or DTX or missed RAR) for intra-network (e.g., intra-cell) UL transmission and receives an uplink transmission from the UE, where the UE adjusts its transmission power for an UL physical channel transmission based on an interference amount determined based on at least one of the interference measurement and the acknowledgment feedback.

In some embodiments, the measurement configuration indicates a threshold interference value. In such embodiments, the UE reduces its maximum transmission power of the UL physical channel transmission in response to a measured interference level exceeding the threshold interference value, where a higher measured interference level causes a greater reduction of the maximum transmit power.

In some embodiments, the transceiver 825 transmits a configuration of gamma value factor for UL transmit power control, where the UE determines its UL transmit power control by multiplying a PCMAX value by the gamma value and the measured interference value. For example, the UE determines its UL transmit power using the above UL transmit power control Equation 1 or Equation 2 with the addition of gamma factor and measured interference value.

In some embodiments, the transceiver 825 transmits a mapping table that maps a PCMAX value of a physical uplink channel (e.g., PUSCH) to be used by the UE for a range of measured interference level. In such embodiments, the UE uses the mapping table to adjust its maximum transmission power according to the measured interference level.

In some embodiments, the transceiver 825 further transmits a mapping table that maps a maximum P0 nominal power of a physical uplink channel (e.g., PUSCH and/or PUCCH) to be used by a UE for a range of measured interference level. In such embodiments, the UE uses the mapping table to adjust its maximum P0 nominal power according to a measured interference level.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to non-LBT based fair coexistence. For example, the memory 810 may store parameters, configurations, resource assignments, policies, and the like, as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with network functions in the Public Land Mobile Network (“PLMN”) and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

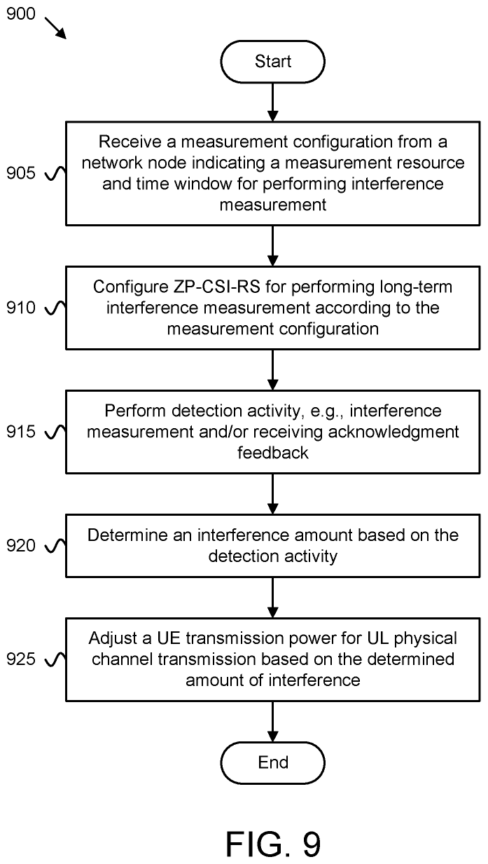

FIG. 9 depicts one embodiment of a method 900 for non-LBT based fair coexistence, according to embodiments of the disclosure. In various embodiments, the method 900 is performed by a user equipment device, such as the remote unit 105, the UE 205, and/or the user equipment apparatus 700, as described above. In some embodiments, the method 900 is performed by a processor, such as a microcontroller, a microprocessor, a CPU, a GPU, an auxiliary processing unit, a FPGA, or the like.

The method 900 begins and receives 905 a measurement configuration from a network node (e.g., RAN entity) indicating a measurement resource and time window for performing interference measurement. The method 900 includes configuring 910 a ZP-CSI-RS for performing long-term interference measurement according to the measurement configuration. The method 900 includes performing 915 detection activity. Here, the detection activity includes at least one of: A) performing an interference measurement on a plurality of beams within a configured time window using the configured measurement resource; and B) receiving acknowledgment feedback from the network node (e.g., NACK or DTX or missed RAR) for intra-network (e.g., intra-cell) transmission. The method 900 includes determining 920 an interference amount based on the detection activity (e.g., the interference measurement and/or the acknowledgment feedback). The method 900 includes adjusting 925 a UE transmission power for a UL physical channel transmission based on the determined amount of interference. The method 900 ends.

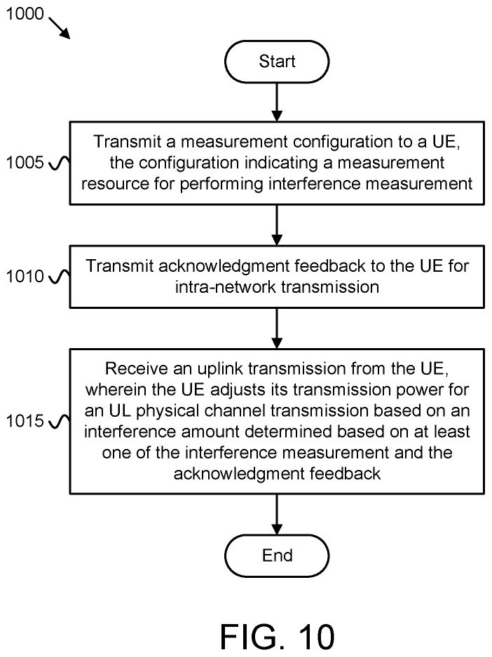

FIG. 10 depicts one embodiment of a method 1000 for non-LBT based fair coexistence, according to embodiments of the disclosure. In various embodiments, the method 1000 is performed by a RAN device, such as the base unit 121, the RAN node 210 and/or the network apparatus 800, as described above. In some embodiments, the method 1000 is performed by a processor, such as a microcontroller, a microprocessor, a CPU, a GPU, an auxiliary processing unit, a FPGA, or the like.

The method 1000 begins and transmits 1005 a measurement configuration to a UE, the configuration indicating a measurement resource for performing interference measurement. The method 1000 includes transmitting 1010 acknowledgment feedback to the UE (e.g., NACK or DTX or missed RAR) for intra-network transmission. The method 1000 includes receiving 1015 an uplink transmission from the UE, where the UE adjusts its transmission power for an UL physical channel transmission based on an interference amount determined based on at least one of the interference measurement and the acknowledgment feedback. The method 1000 ends.

Disclosed herein is a first apparatus for non-LBT based fair coexistence, according to embodiments of the disclosure. The first apparatus may be implemented by a UE device, such as the remote unit 105, the UE 205, and/or the user equipment apparatus 700, described above. The first apparatus includes a processor and a transceiver (e.g., implementing a radio interface) that receives a measurement configuration from a network node (e.g., a RAN entity) indicating a measurement resource and time window for performing interference measurement. The processor configures a zero-power channel state information reference signal (“ZP-CSI-RS”) for performing long-term interference measurement according to the measurement configuration and performs detection activity. Here, the detection activity includes at least one of: A) performing an interference measurement on a plurality of beams within a configured time window using the configured measurement resource; and B) receiving acknowledgment feedback from the network node (e.g., NACK or DTX or missed RAR) for intra-network (e.g., intra-cell) transmission. The processor determines an interference amount based on the detection activity (e.g., the interference measurement and/or the acknowledgment feedback) and adjusts a UE transmission power for an uplink (“UL”) physical channel transmission based on the determined amount of interference.

In some embodiments, the measurement configuration indicates a threshold interference value. In such embodiments, adjusting the UE transmission power includes reducing a maximum transmission power of the UL physical channel transmission in response to a measured interference level exceeding the threshold interference value, where a higher measured interference level causes a greater reduction of the maximum transmit power.

In some embodiments, the transceiver further receives a configuration of gamma value factor for UL transmit power control. In such embodiments, adjusting the UE transmission power includes determining the UL transmit power control by multiplying a PCMAX value by the gamma value and the measured interference value.

In some embodiments, the transceiver further receives a mapping table that maps a PCMAX value of a physical uplink channel (e.g., PUSCH) to be used by a UE for a range of measured interference level. In such embodiments, adjusting the UE transmission power includes using the mapping table to adjust the maximum transmission power according to the measured interference level.

In some embodiments, the transceiver further receives a mapping table that maps a maximum P0 nominal power of a physical uplink channel (e.g., PUSCH and/or PUCCH) to be used by a UE for a range of measured interference level. In such embodiments, adjusting the UE transmission power includes using the mapping table to adjust the maximum P0 nominal power according to a measured interference level.

In some embodiments, the processor further tracks a number of consecutive NACK or DTX or missed RAR or SR failure. Here, the processor reduces the UE transmission power when the number of consecutive NACK or DTX or missed RAR or SR failure exceeds a configured maximum counter value.

In certain embodiments, tracking the number of consecutive NACK or DTX or missed RAR or SR failure includes initializing a counter value to zero and incrementing the counter value upon detecting a NACK or DTX or missed RAR or SR failure. Moreover, the tracking further includes comparing the counter value against the configured maximum counter value and resetting the counter value to zero after the reception of ACK.

In certain embodiments, the processor further maintains a NACK-based counter for each transmit beam for which HARQ reporting is generated. In such embodiments, a particular NACK-based counter is incremented upon detecting a NACK for a corresponding transmit beam.

In certain embodiments, the processor further maintains a DTX-based counter for each transmit beam for which HARQ ACK/NACK was not received. In such embodiments, a particular DTX-based counter is incremented upon detecting DTX for a corresponding transmit beam.

In certain embodiments, the processor further maintains a RAR-based counter for consecutive failures of RAR within a configured RACH Response Window. In certain embodiments, the processor further maintains a SR-based counter for consecutive failures of SR prior to expiration of SR prohibit timer.

In some embodiments, the processor further switches a transmit beam in response to detecting a consistent interferer based on at least one of the interference measurement and the acknowledgment feedback. In some embodiments, the processor further switches an active UL BWP transmit beam in response to detecting a consistent interferer based on at least one of the interference measurement and the acknowledgment feedback.

Disclosed herein is a first method for non-LBT based fair coexistence, according to embodiments of the disclosure. The first method may be performed by a UE device, such as the remote unit 105, the UE 205, and/or the user equipment apparatus 700, described above. The first method includes receiving a measurement configuration from a network node (e.g., RAN entity) indicating a measurement resource and time window for performing interference measurement and configuring a ZP-CSI-RS for performing long-term interference measurement according to the measurement configuration. The first method includes performing detection activity, the detection activity includes at least one of: A) performing an interference measurement on a plurality of beams within a configured time window using the configured measurement resource; and B) receiving acknowledgment feedback from the network node (e.g., NACK or DTX or missed RAR) for intra-network (e.g., intra-cell) transmission. The first method includes determining an interference amount based on the detection activity (e.g., the interference measurement and/or the acknowledgment feedback) and adjusting a UE transmission power for a UL physical channel transmission based on the determined amount of interference.

In some embodiments, the measurement configuration indicates a threshold interference value. In such embodiments, adjusting the UE transmission power includes reducing a maximum transmission power of the UL physical channel transmission in response to a measured interference level exceeding the threshold interference value, where a higher measured interference level causes a greater reduction of the maximum transmit power.

In some embodiments, the first method includes receiving configuration of gamma value factor for UL transmit power control. In such embodiments, adjusting the UE transmission power includes determining the UL transmit power control by multiplying a PCMAX value by the gamma value and the measured interference value.

In some embodiments, the first method includes receiving a mapping table that maps a PCMAX value of a physical uplink channel (e.g., PUSCH) to be used by a UE for a range of measured interference level. In such embodiments, adjusting the UE transmission power includes using the mapping table to adjust the maximum transmission power according to the measured interference level.

In some embodiments, the first method includes receiving a mapping table that maps a maximum P0 nominal power of a physical uplink channel (e.g., PUSCH and/or PUCCH) to be used by a UE for a range of measured interference level. In such embodiments, adjusting the UE transmission power includes using the mapping table to adjust the maximum P0 nominal power according to a measured interference level.

In some embodiments, the first method includes tracking a number of consecutive NACK or DTX or missed RAR or SR failure and reducing the UE transmission power when the number of consecutive NACK or DTX or missed RAR or SR failure exceeds a configured maximum counter value.

In certain embodiments, tracking the number of consecutive NACK or DTX or missed RAR or SR failure includes: A) initializing a counter value to zero; B) incrementing the counter value upon detecting a NACK or DTX or missed RAR or SR failure; C) comparing the counter value against the configured maximum counter value; and D) resetting the counter value to zero after the reception of ACK.

In certain embodiments, the first method further includes maintaining a NACK-based counter for each transmit beam for which HARQ reporting is generated. In such embodiments, a particular NACK-based counter is incremented upon detecting a NACK for a corresponding transmit beam.

In certain embodiments, the first method further includes maintaining a DTX-based counter for each transmit beam for which HARQ ACK/NACK was not received. In such embodiments, a particular DTX-based counter is incremented upon detecting DTX for a corresponding transmit beam.

In certain embodiments, the first method further includes maintaining a RAR-based counter for consecutive failures of RAR within a configured RACH Response Window. In certain embodiments, the first method further includes maintaining a SR-based counter for consecutive failures of SR prior to expiration of SR prohibit timer.

In some embodiments, the first method includes switching a transmit beam in response to detecting a consistent interferer based on at least one of the interference measurement and the acknowledgment feedback. In some embodiments, the first method includes switching an active UL BWP transmit beam in response to detecting a consistent interferer based on at least one of the interference measurement and the acknowledgment feedback.

Disclosed herein is a second apparatus for non-LBT based fair coexistence, according to embodiments of the disclosure. The second apparatus may be implemented by a device in a radio access network (“RAN”), such as the base unit 121, the RAN node 210, and/or the network apparatus 800, described above. The second apparatus includes a processor and a transceiver (i.e., implementing a radio interface) that transmits a measurement configuration to a UE, the configuration indicating a measurement resource (e.g., ZP-CSI-RS) for performing interference measurement. The transceiver transmits acknowledgment feedback to the UE (e.g., NACK or DTX or missed RAR) for intra-network (e.g., intra-cell) UL transmission and receives an uplink transmission from the UE, where the UE adjusts its transmission power for an UL physical channel transmission based on an interference amount determined based on at least one of the interference measurement and the acknowledgment feedback.

In some embodiments, the measurement configuration indicates a threshold interference value. In such embodiments, the UE reduces its maximum transmission power of the UL physical channel transmission in response to a measured interference level exceeding the threshold interference value, where a higher measured interference level causes a greater reduction of the maximum transmit power.

In some embodiments, the transceiver further transmits a configuration of gamma value factor for UL transmit power control, where the UE determines its UL transmit power control by multiplying a PCMAX value by the gamma value and the measured interference value.

In some embodiments, the transceiver further transmits a mapping table that maps a PCMAX value of a physical uplink channel (e.g., PUSCH) to be used by the UE for a range of measured interference level. In such embodiments, the UE uses the mapping table to adjust its maximum transmission power according to the measured interference level.

In some embodiments, the transceiver further transmits a mapping table that maps a maximum P0 nominal power of a physical uplink channel (e.g., PUSCH and/or PUCCH) to be used by a UE for a range of measured interference level. In such embodiments, the UE uses the mapping table to adjust its maximum P0 nominal power according to a measured interference level.

Disclosed herein is a second method for non-LBT based fair coexistence, according to embodiments of the disclosure. The second method may be performed by a device in a RAN, such as the base unit 121, the RAN node 210, and/or the network apparatus 800, described above. The second method includes transmitting a measurement configuration to a UE, the configuration indicating a measurement resource for performing interference measurement. The second method includes transmitting acknowledgment feedback to the UE (e.g., NACK or DTX or missed RAR) for intra-network transmission and receiving an uplink transmission from the UE, where the UE adjusts its transmission power for an UL physical channel transmission based on an interference amount determined based on at least one of the interference measurement and the acknowledgment feedback.

In some embodiments, the measurement configuration indicates a threshold interference value. In such embodiments, the UE reduces its maximum transmission power of the UL physical channel transmission in response to a measured interference level exceeding the threshold interference value, where a higher measured interference level causes a greater reduction of the maximum transmit power.

In some embodiments, the second method includes transmitting a configuration of gamma value factor for UL transmit power control, where the UE determines its UL transmit power control by multiplying a PCMAX value by the gamma value and the measured interference value.

In some embodiments, the second method includes transmitting a mapping table that maps a PCMAX value of a physical uplink channel (e.g., PUSCH) to be used by a UE for a range of measured interference level. In such embodiments, the UE uses the mapping table to adjust its maximum transmission power according to the measured interference level.

In some embodiments, the second method includes transmitting a mapping table that maps a maximum P0 nominal power of a physical uplink channel (e.g., PUSCH and/or PUCCH) to be used by a UE for a range of measured interference level. In such embodiments, adjusting the UE transmission power includes using the mapping table to adjust the maximum P0 nominal power according to a measured interference level.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A User Equipment (“UE”) apparatus comprising:
a processor; and
a memory coupled to the processor, the memory comprising instructions executable by the processor to cause the UE apparatus to:
receive, from a network node, a measurement configuration indicating a measurement resource and a time window for performing an interference measurement;
configure a zero-power channel state information reference signal (“ZP-CSI-RS”) for performing the interference measurement based on the measurement configuration;
perform a detection activity comprising:
performing the interference measurement on a plurality of beams within the time window using the measurement resource,
receiving acknowledgment feedback from the network node for an intra-network transmission,
or both;
determine an interference amount based on the detection activity; and
adjust a UE transmission power for an uplink (“UL”) physical channel transmission based on the interference amount.

17. The UE apparatus of claim 16, wherein the measurement configuration indicates a threshold interference value, wherein to adjust the UE transmission power, the instructions are executable by the processors to cause the UE apparatus to reduce a maximum transmission power of the UL physical channel transmission in response to a measured interference level exceeding the threshold interference value, and wherein a higher measured interference level causes a greater reduction of the maximum transmit power.

18. The UE apparatus of claim 16, wherein the instructions are executable by the processor to cause the UE apparatus to receive a configuration of gamma value factor for UL transmit power control, and wherein to adjust the UE transmission power, the instructions are executable by the processors to cause the UE apparatus to determine determining the UL transmit power control by multiplying a maximum UE transmit power value by the gamma value and a measured interference value.

19. The UE apparatus of claim 16, wherein the instructions are executable by the processor to cause the UE apparatus to receive a mapping table that maps a maximum UE transmit power value of a physical uplink channel to be used by the UE apparatus over a range of measured interference level, and wherein to adjust the UE transmission power, the instructions are executable by the processors to cause the UE apparatus to adjust the maximum transmission power based on the mapping table and a measured interference level.

20. The UE apparatus of claim 16, wherein the instructions are executable by the processor to cause the UE apparatus to receive a mapping table that maps a maximum nominal power of a physical uplink channel to be used by the apparatus over a range of measured interference level, and wherein to adjust the UE transmission power, the instructions are executable by the processors to cause the UE apparatus to adjust the maximum nominal power based on the mapping table and a measured interference level.

21. The UE apparatus of claim 16, wherein the instructions are executable by the processor to cause the UE apparatus to:
track a number of consecutive negative acknowledgement (“NACK”) or consecutive discontinuous transmission (“DTX”) or consecutive missed Random-Access Response (“RAR”) or consecutive Scheduling Request (“SR”) failure; and
reduce the UE transmission power based on the number of consecutive NACK or consecutive DTX or consecutive missed RAR or consecutive SR failure exceeding a configured maximum counter value.

22. The UE apparatus of claim 21, wherein to track the number of consecutive NACK or DTX or missed RAR or SR failure the instructions are executable by the processor to cause the UE apparatus to:
initialize a counter value to zero;
increment the counter value based on detecting a NACK or DTX or missed RAR or SR failure;
compare the counter value against the configured maximum counter value; and
reset the counter value to zero based on reception of a positive acknowledgement (“ACK”).

23. The UE apparatus of claim 21, wherein the instructions are executable by the processor to cause the UE apparatus to maintain a NACK-based counter for each transmit beam for which Hybrid Automatic Repeat Request (“HARQ”) reporting is generated, and wherein a particular NACK-based counter is incremented based on detecting a NACK for a corresponding transmit beam.

24. The UE apparatus of claim 21, wherein the instructions are executable by the processor to cause the UE apparatus to further maintains a DTX-based counter for each transmit beam for which HARQ feedback was not received, and wherein a particular DTX-based counter is incremented based on detecting DTX for a corresponding transmit beam.

25. The UE apparatus of claim 21, wherein the instructions are executable by the processor to cause the UE apparatus to maintain a RAR-based counter for consecutive failures of RAR within a configured RACH Response Window.

26. The UE apparatus of claim 21, wherein the instructions are executable by the processor to cause the UE apparatus to maintain a SR-based counter for consecutive failures of SR prior to expiration of SR prohibit timer.

27. The UE apparatus of claim 16, wherein the instructions are executable by the processor to cause the UE apparatus to switch a transmit beam in response to detecting a consistent interferer based on the interference measurement or the acknowledgment feedback.

28. The UE apparatus of claim 16, wherein the instructions are executable by the processor to cause the UE apparatus to switch an active UL BWP transmit beam in response to detecting a consistent interferer based on the interference measurement or the acknowledgment feedback.

29. A method of a User Equipment (“UE”), the method comprising:
receiving, from a network node, a measurement configuration indicating a measurement resource and a time window for performing an interference measurement;
configuring a zero-power channel state information reference signal (“ZP-CSI-RS”) for performing the interference measurement based on the measurement configuration;
performing a detection activity comprising:
performing the interference measurement on a plurality of beams within the time window using the measurement resource,
receiving acknowledgment feedback from the network node for an intra-network transmission,
or both;
determining an interference amount based on the detection activity; and
adjusting a UE transmission power for an uplink (“UL”) physical channel transmission based on the interference amount.

30. A Radio Access Network (“RAN”) apparatus comprising:
a processor; and
a memory coupled to the processor, the memory comprising instructions executable by the processor to cause the RAN apparatus to:
transmit, to a User Equipment (“UE”), a measurement configuration indicating a measurement resource for performing an interference measurement;
transmit, to the UE, an acknowledgment feedback for an intra-network transmission; and
receive, from the UE, an uplink (“UL”) physical channel transmission having an adjusted transmission power based on an interference amount determined based on at least one of the interference measurement and the acknowledgment feedback.

31. The RAN apparatus of claim 30, wherein the measurement configuration indicates a threshold interference value at which a maximum transmission power of the UL physical channel transmission is to be reduced based on a measured interference level, and wherein a higher measured interference level causes a greater reduction of the maximum transmit power.

32. The RAN apparatus of claim 30, wherein the instructions are executable by the processor to cause the RAN apparatus to configure a gamma value factor for UL transmit power control, and wherein the adjusted transmission power is based on a maximum UE transmit power value multiplied by the gamma value and a measured interference value.

33. The RAN apparatus of claim 30, wherein the instructions are executable by the processor to cause the RAN apparatus to transmit a mapping table that maps a maximum UE transmit power value of a physical uplink channel to be used by the UE over a range of measured interference level, and wherein the adjusted transmission power is based on the mapping table and a measured interference level.

34. The RAN apparatus of claim 30, wherein the instructions are executable by the processor to cause the RAN apparatus to transmit a mapping table that maps a maximum nominal power of a physical uplink channel to be used by the UE over a range of measured interference level, and wherein the adjusted transmission power is based on the mapping table and a measured interference level.
